(19) United States
(12) Patent Application Publication
(10) Pub. No.: US 2026/0172748 A1
(43) Pub. Date: Jun. 18, 2026

(54) Signal Processing Method, Signal Processing System, and Speaker System

(71) Applicant: Yamaha Corporation, Hamamatsu-shi (JP)

(72) Inventors: Ryoya TABATA, Hamamatsu-shi (JP); Katsuya UCHIDA, Iwata-shi (JP); Shota FURUKAWA, Hamamatsu-shi (JP); Tasuku KUROSAWA, Hamamatsu-shi (JP)

(21) Appl. No.: 19/533,725

(22) Filed: Feb. 9, 2026

Related U.S. Application Data
(63) Continuation of application No. PCT/JP2024/028222, filed on Aug. 7, 2024.

(30) Foreign Application Priority Data
Aug. 9, 2023 (JP) 2023-130272

(51) Int. Cl. H04R 3/02

(52) U.S. Cl. CPC H04R 3/02

(57) ABSTRACT

A sound processing system includes a signal processor configured to determine, by use of a nonlinear model, an input voltage based on a target parameter, including a volume velocity at a sound port, for sound radiation utilizing Helmholtz resonance, the nonlinear model simulating a relationship in which an acoustic resistance at the sound port depends on the volume velocity at the sound port; and includes a voltage supplier configured to supply the input voltage to a speaker apparatus.

### CROSS REFERENCE TO RELATED APPLICATIONS

This application is a Continuation Application of PCT Application No. PCT/JP2024/028222, filed Aug. 7, 2024, is based on and claims priority from Japanese Patent Application No. 2023-130272, filed on Aug. 9, 2023, the entire contents of each of which are incorporated herein by reference.

### TECHNICAL FIELD

The present disclosure relates to techniques for reducing nonlinear distortion of sound radiated from a speaker apparatus.

### BACKGROUND

Nonlinear distortion such as harmonic distortion is generated in reproduced sound radiated from the speaker apparatus. For example, U.S. patent Ser. No. 10/547,942 discloses a technique of reducing nonlinear distortion of reproduced sound by using a nonlinear model that simulates a speaker unit in a speaker apparatus.

A speaker apparatus is provided with a sound port (for example, a bass reflex port) for sound radiation using Helmholtz resonance. In addition to nonlinear distortion attributable to a speaker unit, the reproduced sound emitted by the speaker apparatus may be accompanied by nonlinear distortion attributable to the sound port.

### SUMMARY

In view of the above circumstances, an object of one aspect of the present disclosure is to reduce nonlinear distortion in the reproduced sound from a speaker apparatus.

To solve the above problem, a signal processing method according to an aspect of the present disclosure determines, by use of a nonlinear model, an input voltage based on a target parameter including a volume velocity at a sound port for sound radiation utilizing Helmholtz resonance, the nonlinear model simulating a relationship in which an acoustic resistance at the sound port depends on the volume velocity at the sound port; and supplies the input voltage to a speaker apparatus.

A signal processing system according to an aspect of the present disclosure includes: a signal processor configured to determine, by use of a nonlinear model, an input voltage based on a target parameter including a volume velocity at a sound port for sound radiation utilizing Helmholtz resonance, the nonlinear model simulating a relationship in which an acoustic resistance at the sound port depends on the volume velocity at the sound port; and a voltage supplier configured to supply the input voltage to a speaker apparatus.

A speaker system according to an aspect of the present disclosure includes a speaker unit; a sound port for sound radiation utilizing Helmholtz resonance of a sound radiated from the speaker unit; and a signal processing system. The signal processing system includes: a signal processor configured to determine, by use of a nonlinear model, an input voltage based on a target parameter including a volume velocity at the sound port, the nonlinear model simulating a relationship in which an acoustic resistance at the sound port depends on the volume velocity at the sound port; and a voltage supplier configured to supply the input voltage to a speaker apparatus.

### BRIEF DESCRIPTION OF THE DRAWINGS

FIG. 1 is a schematic diagram of a speaker system according to a first embodiment.

FIG. 2 is a side view of a speaker unit.

FIG. 3 is a block diagram of a signal processing system.

FIG. 4 is a schematic diagram of a nonlinear model.

FIG. 5 is a flowchart of distortion reduction processing.

FIG. 6 is a flowchart of second processing.

FIG. 7 is a flowchart of distortion reduction processing according to a second embodiment.

FIG. 8 is a schematic diagram of a speaker system according to a third embodiment.

FIG. 9 shows a part of the flowchart of the distortion reduction processing according to the second embodiment.

FIG. 10 is a cross-sectional view of a speaker apparatus according to a modification.

FIG. 11 is a cross-sectional view of a speaker apparatus according to a modification.

### DETAILED DESCRIPTION

### A: First Embodiment

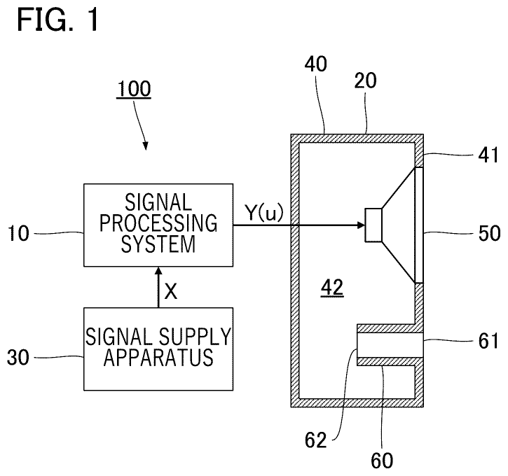

FIG. 1 is a schematic diagram showing a configuration of a speaker system 100 according to a first embodiment. The speaker system 100 of the first embodiment includes a signal processing system 10 and a speaker apparatus 20. An audio signal X is supplied to the signal processing system 10 from a signal supply apparatus 30. The audio signal X is a signal representing a sound waveform. For example, the audio signal X is a sample sequence representing a waveform of a singing sound or an instrumental sound of a piece of music.

The signal supply apparatus 30 is, for example, a reproduction apparatus that supplies an audio signal X recorded on a recording medium to the signal processing system 10. A communication apparatus that supplies an audio signal X received from a distribution apparatus (not shown) via a communication network to the signal processing system 10, or a sound receiver that generates an audio signal X by receiving surrounding sounds can also be used as the signal supply apparatus 30. The signal supply apparatus 30 can be understood as an element of the speaker system 100.

The signal processing system 10 generates an audio signal Y by performing signal processing on the audio signal X, and supplies the generated audio signal Y to the speaker apparatus 20. The speaker apparatus 20 is a sound emitting apparatus that emits sound represented by the audio signal Y.

The speaker apparatus 20 includes a housing 40 (enclosure), a speaker unit 50, and a sound port 60. The housing 40 is a hollow structure that supports the speaker unit 50 and the sound port 60. The speaker unit 50 and the sound port 60 are installed on a plate member 41 (baffle plate) located on the front of the housing 40. The sound port 60 may be installed on the rear side of the housing 40.

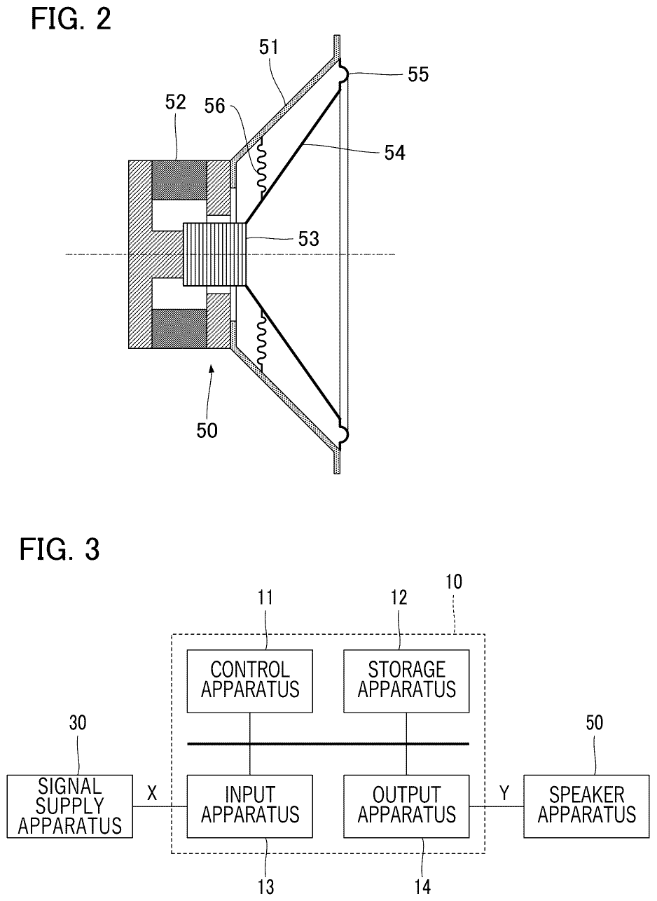

The speaker unit 50 emits sound represented by the audio signal Y supplied from the signal processing system 10. FIG. 2 is a cross-sectional view of the speaker unit 50. The speaker unit 50 of the first embodiment includes a frame 51, a magnet 52, a voice coil 53, a diaphragm 54, an edge 55, and a damper 56.

The frame 51 is a structure constituting the exterior of the speaker unit 50. The magnet 52 is an annular permanent magnet. The voice coil 53 is a coil that is displaceable in the axial direction in the magnetic field generated by the magnet 52. The diaphragm 54 is a truncated conical structure. An inner peripheral edge of the diaphragm 54 is fixed to the voice coil 53. The outer peripheral edge of the diaphragm 54 is connected to the frame 51 via the edge 55. The diaphragm 54 and the frame 51 are connected to each other via the damper 56. The edge 55 and the damper 56 are each annular elastic bodies. When the diaphragm 54 reciprocates in the axial direction, a sound wave is radiated.

The sound port 60 in FIG. 1 is a bass reflex port that radiates acoustic components in a low-frequency range radiated from the speaker unit 50 to the back side of the housing 40, by enhancing the acoustic components in the low-frequency range by Helmholtz resonance. That is, the speaker apparatus 20 of the first embodiment is of a bass reflex type. The sound port 60 is installed inside the housing 40 and communicates an internal space 42 of the housing 40 with an external space of the housing 40. Specifically, the sound port 60 is a substantially cylindrical tubular body including an outer opening 61 and an inner opening 62. The outer opening 61 is an open end that communicates with the opening of the plate member 41. The inner opening 62 is an open end located inside the housing 40.

In the above-described configuration, sound radiated from the speaker unit 50 to the back side propagates from the internal space 42 of the housing 40 to the sound port 60, passes through the sound port 60, and radiates to the external space. As described above, the sound reproduced by the speaker apparatus 20 includes the sound radiated from the speaker unit 50 and the sound radiated from the sound port 60.

In the sound reproduced by the speaker apparatus 20, acoustic components in the high-frequency range, in particular, are accompanied by nonlinear distortions attributable to the nonlinearities of the elements constituting the speaker apparatus 20. The signal processing system 10 generates the audio signal Y from the audio signal X such that the nonlinear distortion attributable to the nonlinearity of the speaker apparatus 20 is reduced. Specifically, the signal processing system 10 reduces the nonlinear distortion by using a nonlinear model M that simulates the behavior of the speaker apparatus 20.

FIG. 3 is a block diagram showing a configuration of the signal processing system 10. As shown in FIG. 3, the signal processing system 10 includes a control apparatus 11, a storage apparatus 12, an input apparatus 13, and an output apparatus 14. The signal processing system 10 is realized by an information apparatus such as a smartphone, a tablet terminal, or a personal computer. It is of note that the signal processing system 10 can be realized not only as a single apparatus but also as a plurality of apparatuses configured separately from one another.

The control apparatus 11 includes one or more processors that control each element of the signal processing system 10. For example, the control apparatus 11 includes one or more types of processors such as a CPU (Central Processing Unit), an SPU (Sound Processing Unit), a DSP (Digital Signal Processor), an FPGA (Field Programmable Gate Array), or an ASIC (Application Specific Integrated Circuit).

The storage apparatus 12 comprises one memory or multiple memories that store programs executed by the control apparatus 11 and various types of data used by the control apparatus 11. The storage apparatus 12 comprises a known recording medium, such as a magnetic recording medium or a semiconductor recording medium. The storage apparatus 12 may be constituted of a combination of more than one type of recording media. Further, a portable recording medium that is attachable to and detachable from the signal processing system 10 or a recording medium (for example, cloud storage) that can be written or read by the control apparatus 11 via a communication network may be used as the storage apparatus 12.

The input apparatus 13 receives the audio signal X from the signal supply apparatus 30. For example, input interfaces such as a USB (Universal Serial Bus) terminal, an HDMI (High-Definition Multimedia Interface, registered trademark) terminal, a MIDI (Musical Instrument Digital Interface) terminal, or a phone terminal are used as the input apparatus 13. In a configuration in which the analog audio signal X is supplied from the signal supply apparatus 30, an A/D converter that converts the audio signal X from analog to digital is mounted to the input apparatus 13.

The output apparatus 14 supplies the audio signal Y to the speaker apparatus 20. Specifically, the output apparatus 14 includes a D/A converter that converts the audio signal Y from digital to analog, and an amplifier that amplifies the audio signal Y. An output apparatus 14 separate from the signal processing system 10 may be connected to the signal processing system 10 by wire or wirelessly. The output apparatus 14 is an example of a “voltage supplier.”

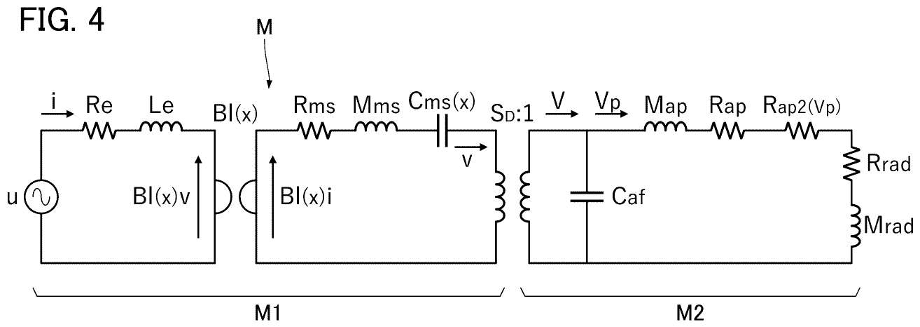

FIG. 4 is a schematic diagram of a nonlinear model M used by the signal processing system 10 to generate the audio signal Y. The nonlinear model M is an equivalent circuit that simulates the speaker unit 50 and the sound port 60 in the speaker apparatus 20. The nonlinear model M includes a first model M1 and a second model M2. The first model M1 is a nonlinear mathematical model that simulates the speaker unit 50, and the second model M2 is a nonlinear mathematical model that simulates the sound port 60.

The input voltage u of the first model M1 is a voltage supplied to the voice coil 53. That is, the signal value of the audio signal Y corresponds to the input voltage u. The input current i is a current flowing through the voice coil 53.

As illustrated in FIG. 4, the first model M1 includes an axial displacement x and a velocity v of the diaphragm 54 in the axial direction, an electric resistance Re and an inductance Le of the voice coil 53, and a force factor (electro-magnetic conversion coefficient) Bl(x) of the voice coil 53. The force factor Bl(x) is the product of the magnetic flux density B of the voice coil 53 and the winding length 1, and varies nonlinearly in accordance with the displacement x of the diaphragm 54.

The first model M1 also includes a mechanical resistance Rms, a mass Mms, and a compliance Cms(x) of a vibrating system. The compliance Cms(x) is the reciprocal of the spring constant Kms(x) of the vibrating system, as expressed by the following equation. The spring constant Kms(x) and the compliance Cms(x) vary nonlinearly in accordance with the displacement x of the diaphragm 54.

$${C}_{ms} ( x ) = 1 / {K}_{ms} ( x )$$

The second model M2 of the nonlinear model M includes a volume velocity V, a volume velocity Vp, and an acoustic compliance Caf. The volume velocity Vis a flow rate (volume flow rate) of the air flow generated in the internal space 42 of the housing 40 by the vibration of the diaphragm 54. The volume velocity Vp is a flow rate (volume flow rate) of the air flow generated inside the sound port 60. The acoustic compliance Caf is the acoustic compliance in the internal space 42 of the housing 40.

The second model M2 also includes an acoustic resistance Rap and an acoustic mass Map at the sound port 60, an acoustic resistance Rrad and an acoustic mass Mrad associated with sound radiation from the sound port 60 to the external space, and a nonlinear acoustic resistance Rap2(Vp) at the sound port 60.

The sound behaves like a fluid inside the sound port 60. In the flow path from the internal space 42 leading to the inside of the sound port 60, the cross-sectional area is abruptly reduced at the boundary between the internal space 42 and the sound port 60 (the vicinity of the inner opening 62). As a result, a contraction effect is generated in the vicinity of the inner opening 62 inside the sound port 60.

The contraction effect in the sound port 60 causes the acoustic resistance Rap2(Vp) at the sound port 60 to vary in accordance with the volume velocity Vp in the sound port 60. As will be understood from the above explanation, the nonlinear model M (specifically, the second model M2) simulates a relationship in which the acoustic resistance Rap2(Vp) at the sound port 60 depends on the volume velocity Vp at the sound port 60. The acoustic resistance Rap2(Vp) can also be expressed as a component of the acoustic resistance within the sound port 60 that depends on the volume velocity Vp.

In the nonlinear model M described above, Equation (1) to Equation (3) are established.

$$u = {R}_{e} i + {L}_{e} \frac{di}{dt} + Bl ( x ) v \qquad ( 1 )$$

$$Bl ( x ) i = {M}_{ms} \frac{dv}{dt} + {R}_{ms} v + {K}_{ms} ( x ) x + \frac{{S}_{D}}{{C}_{af}} \int ( V - {V}_{p} ) dt \qquad ( 2 )$$

$$\frac{1}{{C}_{af}} \int ( V - {V}_{p} ) = {R}_{ap}^{′} {V}_{p} + {R}_{ap 2} ( {V}_{p} ) {V}_{p} + {M}_{ap}^{′} \frac{{dV}_{p}}{dt} \qquad ( 3 )$$

The acoustic resistance Rap′ and the acoustic mass Map′ in Equation (3) are expressed by Equation (4) below.

$$\begin{matrix}{R}_{ap}^{′} = {R}_{ap} + {R}_{rad} \\ {M}_{ap}^{′} = {M}_{ap} + {M}_{rad}\end{matrix} \qquad ( 4 )$$

In addition, the volume velocity V and the displacement xp are defined as shown in Equation (5) below. As can be seen from Equation (5), the displacement xp is the time integration of the volume velocity Vp and corresponds to the displacement of the air in the sound port 60.

$$\begin{matrix}V = {vS}_{D} \\ {x}_{p} = \int {V}_{p} dt\end{matrix} \qquad ( 5 )$$

By applying Equation (5), Equation (2) is transformed into Equation (6) below, and Equation (3) is transformed into Equation (7) below.

$$Bl ( x ) i = {M}_{ms} \frac{dv}{dt} + {R}_{ms} v + {K}_{ms} ( x ) x + \frac{{S}_{D}}{{C}_{af}} ( {xS}_{D} - {x}_{p} ) \qquad ( 6 )$$

$$\frac{1}{{C}_{af}} ( {xS}_{D} - {x}_{p} ) = {R}_{ap}^{′} {V}_{p} + {R}_{ap 2} ( {V}_{p} ) {V}_{p} + {M}_{ap}^{′} \frac{{dV}_{p}}{dt} \qquad ( 7 )$$

As will be understood from the foregoing, the nonlinear model M includes nonlinear parameters (Bl(x), Kms(x)) associated with the speaker unit 50 and a nonlinear parameter (Rap2(Vp)) associated with the sound port 60. The nonlinear parameter (Rap2(Vp)) associated with the sound port 60 is an example of a “first nonlinear parameter,” and the nonlinear parameters (Bl(x), Kms(x)) associated with the speaker unit 50 are each an example of a “second nonlinear parameter.”

The control apparatus 11 uses the nonlinear model M described above to determine the input voltage u and reduce both the nonlinear distortion attributable to the speaker unit 50 and the nonlinear distortion attributable to the sound port 60. The nonlinear distortion attributable to the speaker unit 50 is harmonic distortion in the sound radiated by the speaker unit 50, and is due to nonlinearities in the force factor Bl(x) and the spring constant Kms(x), both of which depend on the displacement x of the diaphragm 54. The nonlinear distortion attributable to the sound port 60 is harmonic distortion in the sound radiated from the sound port 60 due to a nonlinearity in the acoustic resistance Rap2(Vp), which depends on the volume velocity Vp.

Specifically, the control apparatus 11 determines the input voltage u at predetermined sampling periods by calculations using the nonlinear model M. That is, the audio signal Y supplied from the output apparatus 14 to the speaker apparatus 20 is a voltage signal whose signal value corresponds to the input voltage u.

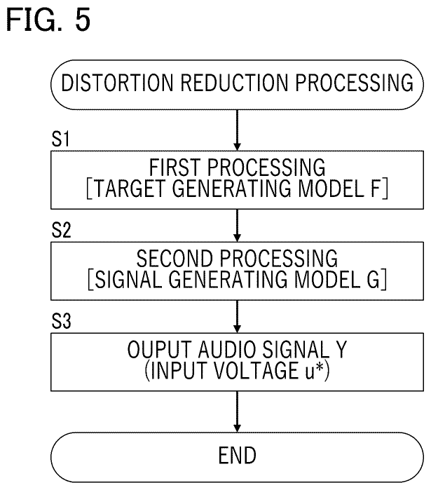

FIG. 5 is a flowchart of processing executed by the control apparatus 11 for determining the input voltage u (hereinafter, “distortion reduction processing”). The distortion reduction processing of FIG. 5 is executed at the predetermined sampling periods.

The distortion reduction processing includes first processing S1 and second processing S2. The first processing S1 is processing for generating a target parameter. The target parameter is a parameter associated with the nonlinear model M. Specifically, the target parameter is an intermediate parameter for reducing the nonlinear distortion in the sound produced by the speaker apparatus 20. In the first embodiment, the target parameter is exemplified as the volume velocity Vp required for the sound port 60 to reduce the nonlinear distortion of the reproduced sound corresponding to the audio signal X.

In the first processing S1, the control apparatus 11 generates the volume velocity Vp by using a target generating model F. The target generating model F is a mathematical model in which nonlinear parameters in the nonlinear model M are linearized. Linearization is processing for ignoring the nonlinearity in the nonlinear model M.

The target generating model F of the first embodiment is a mathematical model in which the nonlinearities of both the speaker unit 50 and the sound port 60 in the nonlinear model M are virtually ignored. That is, in the target generating model F, the nonlinear parameters (Bl(x), Kms(x)) associated with the speaker unit 50 and the nonlinear parameter (Rap2(Vp)) associated with the sound port 60 in the nonlinear model M are linearized. Specifically, the target generating model F is expressed by the following Equation (8a), Equation (9a), and Equation (10a).

$$\begin{matrix}[ TARGET GENERATING MODEL F ] & \\ u = {R}_{e} i + {L}_{e} \frac{di}{dt} + Blv & ( 8 a )\end{matrix}$$

$$Bli = {M}_{ms} \frac{dv}{dt} + {R}_{ms} v + {K}_{ms} x + \frac{{S}_{D}}{{C}_{af}} \int ( V - {V}_{p} ) dt \qquad ( 9 a )$$

$$\frac{1}{{C}_{af}} \int ( V - {V}_{p} ) dt = {R}_{ap}^{′} {V}_{p} + {M}_{ap}^{′} \frac{{dV}_{p}}{dt} \qquad ( 10 a )$$

In Equations (8a) and (9a), the force factor Bl(x), which is a nonlinear parameter of the speaker unit 50 in the equations (1) and (6), is replaced by a predetermined constant Bl. In Equation (9a), the spring constant Kms(x), which is a nonlinear parameter of the speaker unit 50 in Equation (6), is replaced by a predetermined constant Kms. In Equation (10a), the acoustic resistance Rap2(Vp) (to be precise, the sum of the acoustic resistance Rap′ and the acoustic resistance Rap2(Vp)), which is a nonlinear parameter of the sound port 60 in Equation (7), is replaced by a predetermined constant Rap′.

In the first processing S1, the control apparatus 11 calculates the volume velocity Vp when the audio signal X is supplied to the speaker apparatus 20, which is assumed to be a linear system, by applying the signal value of the audio signal X as the input voltage u to Equations (8a) to (10a) of the target generating model F.

As described above, the target parameter of the first embodiment is a volume velocity Vp in an idealized environment in which the nonlinear distortion attributable to the nonlinearity of the speaker unit 50 and the nonlinearity of the sound port 60 is not present. That is, in the first embodiment, the volume velocity Vp for the speaker apparatus 20 to radiate the sound corresponding to the audio signal X is calculated in an idealized environment in which the nonlinearities of the speaker unit 50 and the sound port 60 are ignored.

A known method such as a general state-space model may be freely adopted for solving the simultaneous differential equations. For example, analysis using a state-space model is disclosed, for example in Huang, X. Feng, S. Chen, and Y. Shen, “Analysis of total harmonic distortion of miniature loudspeakers used in mobile phones considering nonlinear acoustic damping,” The Journal of the Acoustical Society of America, vol. 149, no. 3, pp. 1579-1588, March 2021, doi: 10.1121/10.0003644.

As will be understood from the above description, the control apparatus 11 according to the first embodiment functions as an element (target generator) that generates a target parameter by using the target generating model F in which the nonlinear parameters associated with the speaker unit 50 and the sound port 60 in the nonlinear model M (signal generating model G) are linearized.

As illustrated in FIG. 5, the control apparatus 11 executes the second processing S2 after executing the first processing S1. The second processing S2 is processing for determining the input voltage u* using the signal generating model G. Specifically, the control apparatus 11 calculates the input voltage u* required to realize the volume velocity Vp by applying, to the signal generating model G, the volume velocity Vp (that is, the target parameter) calculated by the first processing S1. The signal generating model G corresponds to the above-described nonlinear model M. Specifically, the signal generating model G is expressed by the following Equation (11a), Equation (12a), and Equation (13a). The symbol “*” denotes an ideal numerical value in a virtual environment in which nonlinear distortion does not occur.

$$\begin{matrix}[ SIGNAL GENERATING MODEL G ] & \\ {x}^{*} = \frac{{C}_{af}}{{S}_{D}} ( {R}_{ap}^{′} {V}_{p} + {R}_{ap 2} ( {V}_{p} ) {V}_{p} + {M}_{ap}^{′} \frac{{dV}_{p}}{dt} ) + \frac{{x}_{p}}{{S}_{D}} & ( 11 a )\end{matrix}$$

$$Bl ( {x}^{*} ) {i}^{*} = {M}_{ms} \frac{{dv}^{*}}{dt} + {R}_{ms} {v}^{*} + {K}_{ms} ( {x}^{*} ) {x}^{*} + \frac{{S}_{D}}{{C}_{af}} ( {x}^{*} {S}_{D} - {x}_{p} ) \qquad ( 12 a )$$

$${u}^{*} = {R}_{e} {i}^{*} + {L}_{e} \frac{{di}^{*}}{dt} + Bl ( {x}^{*} ) {v}^{*} \qquad ( 13 a )$$

Expression (11a) corresponds to the above-described Expression (7), and Expression (12a) corresponds to the above-described Expression (6). Expression (13a) corresponds to Expression (1) described above. As described above, the signal generating model G (nonlinear model M) includes a force factor Bl(x) and a spring constant Kms(x), which are nonlinear parameters associated with the speaker unit 50, and an acoustic resistance Rap2(Vp), which is a nonlinear parameter associated with the sound port 60.

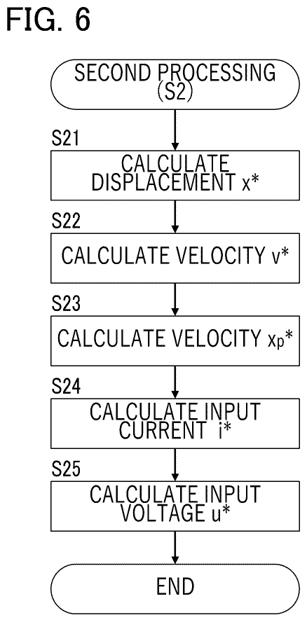

FIG. 6 is a flow chart illustrating an example process of the second processing S2. When the second processing S2 starts, the control apparatus 11 calculates an idealized displacement x* of the diaphragm 54 by applying the volume velocity Vp calculated by the first processing S1 to Equation (11a) of the signal generating model G (S21).

The control apparatus 11 calculates an idealized velocity v* of the diaphragm 54 by differentiating the displacement x* of the diaphragm 54 (S22). In addition, the control apparatus 11 calculates an idealized displacement xp* associated with the sound port 60 by applying, to Equation (5), the volume velocity Vp calculated by the first processing S1 (S23). In the above description, the volume velocity Vp is described as a target parameter. However, a set of the volume velocity Vp and the displacement xp* of the sound port 60 may be interpreted as a target parameter. A set of the volume velocity Vp and the displacement xp* of the sound port 60 and the displacement x* and the velocity v* of the diaphragm 54 may be interpreted as the target parameter. As exemplified above, the target parameter is expressed as a parameter including, for example, the volume velocity Vp at the sound port 60.

The control apparatus 11 calculates an idealized input current i* by applying, to Equation (12a) of the signal generating model G, the displacement x* and the velocity v* of the diaphragm 54, and the volume velocity Vp and the displacement xp* of the sound port 60 (S24). Then, the control apparatus 11 calculates the input voltage u* by applying the displacement x* and the velocity v* of the diaphragm 54 and the input current i* to the mathematical expression (13a) of the signal generating model G (S25). The input voltage u* is the voltage required to achieve the idealized displacement xp* and volume velocity Vp of the sound port 60.

When the first processing S1 and the second processing S2 are executed, as illustrated in FIG. 5, the control apparatus 11 supplies, from the output apparatus 14 to the speaker apparatus 20, the audio signal Y having the signal value set to the input voltage u* (S3). That is, the output apparatus 14 supplies the input voltage u* to the speaker apparatus 20.

As will be understood from the above description, the control apparatus 11 of the first embodiment functions as an element (signal processor) that determines the input voltage u* such that the nonlinear distortion attributable to the sound port 60 is reduced, by using the nonlinear model M that simulates the relationship in which the acoustic resistance Rap2(Vp) in the sound port 60 depends on the volume velocity Vp. According to the above-described configuration, the nonlinear distortion attributable to the sound port 60 can be reduced in the sound reproduced by the speaker apparatus 20.

Further, in the first embodiment, the target generating model F obtained by linearizing the nonlinear parameters (Bl(x), Kms(x)) associated with the speaker unit 50 and the nonlinear parameter (Rap2(Vp)) associated with the sound port 60 in the nonlinear model M are used to calculate the target parameter (volume velocity Vp). Therefore, in addition to the nonlinear distortion attributable to the sound port 60, the nonlinear distortion attributable to the speaker unit 50 can also be reduced.

### B: Second Embodiment

A second embodiment of the present disclosure will now be described. In each of the embodiments illustrated below elements whose functions are the same as those of the first embodiment will be described using the same reference numerals as those of the first embodiment, and detailed descriptions thereof will be omitted as appropriate.

In the second embodiment, the signal generating model G (nonlinear model M) applied to the second processing S2 is different from that in the first embodiment. Specifically, the signal generating model G of the second embodiment is expressed by the following Equation (11b), Equation (12b), and Equation (13b).

$$\begin{matrix}[ SIGNAL GENERATING MODEL G ] & \\ {x}^{*} = \frac{{C}_{af}}{{S}_{D}} ( {R}_{ap}^{′} {V}_{p} + {R}_{ap 2} ( {V}_{p} ) {V}_{p} + {M}_{ap}^{′} \frac{{dV}_{p}}{dt} ) + \frac{{x}_{p}}{{S}_{D}} & ( 11 b )\end{matrix}$$

$${Bli}^{*} = {M}_{ms} \frac{{dv}^{*}}{dt} + {R}_{ms} {v}^{*} + {K}_{ms} {x}^{*} + \frac{{S}_{D}}{{C}_{af}} ( {x}^{*} {S}_{D} - {x}_{p} ) \qquad ( 12 b )$$

$${u}^{*} = {R}_{e} {i}^{*} + {L}_{e} \frac{{di}^{*}}{dt} + {Blv}^{*} \qquad ( 13 b )$$

Equation (11b) of the signal generating model G is similar to Equation (11a) according to the first embodiment. Namely, the signal generating model G of the second embodiment includes the acoustic resistance Rap2(Vp), which is a nonlinear parameter of the sound port 60. The signal generating model G according to the second embodiment is a mathematical model obtained by linearizing the nonlinear parameters (Bl(x), Kms(x)) associated with the speaker unit 50 in the signal generating model G according to the first embodiment. That is, in the signal generating model G, the force factor Bl(x*), which is the nonlinear parameter of the signal generating model G, is replaced by a predetermined constant Bl, and the spring constant Kms(x*), which is the nonlinear parameter of the signal generating model G, is replaced by a predetermined constant Kms, as shown in Equations (12b) and (13b).

The control apparatus 11 calculates the input voltage u* by the second processing S2 in which the target parameter (volume velocity Vp) is applied to the signal generating model G described above. In the first processing S1, the target parameter (volume velocity Vp) is calculated using the same target generating model F as that in the first embodiment.

As described above, also in the second embodiment, the input voltage u* is determined using the signal generating model G (nonlinear model M) that simulates the relationship in which the acoustic resistance Rap2(Vp) at the sound port 60 depends on the volume velocity Vp. Therefore, as in the first embodiment, it is possible to reduce the nonlinear distortion in the sound reproduced by the speaker apparatus 20.

Since the signal generating model G in the first embodiment includes the nonlinear parameter (Bl(x), Kms(x)) of the speaker unit 50 in addition to the nonlinear parameter (Rap2(Vp)) of the sound port 60, the nonlinear distortion attributable to the speaker unit 50 can also be reduced in addition to the nonlinear distortion attributable to the sound port 60. On the other hand, the nonlinear parameter included in the signal generating model G of the second embodiment is only the nonlinear parameter (Rap2(Vp)) of the sound port 60. Therefore, in the second embodiment, what is reduced from the reproduced sound of the speaker apparatus 20 is the nonlinear distortion attributable to the sound port 60.

As described above, the first embodiment is more effective than the second embodiment from a viewpoint of reducing the nonlinear distortion attributable to the speaker unit 50. On the other hand, since the number of nonlinear parameters in the signal generating model G is reduced in the second embodiment, the processing load required for generating the audio signal Y (input voltage u*) is advantageously reduced as compared with the first embodiment.

### C: Third Embodiment

In the third embodiment, the target generating model F applied to the first processing S1 is different from the first embodiment. Specifically, the target generating model F of the third embodiment is expressed by the following Expression (8b), Expression (9b), and Expression (10b). In the first processing S1, the control apparatus 11 calculates the target parameter (specifically, the volume velocity Vp of the sound port 60) by using the target generating model F exemplified below.

$$\begin{matrix}[ TARGET GENERATING MODEL F ] & \\ u = {R}_{e} i + {L}_{e} \frac{di}{dt} + Blv & ( 8 b )\end{matrix}$$

$$Bli = {M}_{ms} \frac{dv}{dt} + {R}_{ms} v + {K}_{ms} x + \frac{{S}_{D}}{{C}_{af}} \int ( V - {V}_{p} ) dt \qquad ( 9 b )$$

$$\frac{1}{{C}_{af}} \int ( V - {V}_{p} ) dt = {R}_{ap}^{′} {V}_{p} + {R}_{ap 2} ( {V}_{p} ) {V}_{p} + {M}_{ap}^{′} \frac{{dV}_{p}}{dt} \qquad ( 10 b )$$

Equation (8b) and Equation (9b) of the target generating model F are similar to Equation (8a) and Equation (9a) according to the first embodiment. That is, in the target generating model F of the third embodiment, the nonlinear parameters (Bl(x), Kms(x)) associated with the speaker unit 50 among the nonlinear models M are linearized. Specifically, in the target generating model F, the force factor Bl(x) of the speaker unit 50 is replaced by a constant Bl, and the spring constant Kms(x) of the speaker unit 50 is replaced by a constant Kms.

On the other hand, as will be understood from Equation (10b), in the target generating model F of the third embodiment, the nonlinear parameter (Rap2(Vp)) associated with the sound port 60 in the nonlinear model M is maintained nonlinearly. As will be understood from the above explanation, the target generating model F according to the third embodiment includes the nonlinear parameter (Rap2(Vp) associated with the sound port 60.

The signal generating model G applied to the second processing S2 in the third embodiment is similar to that in the first embodiment. That is, the signal generating model G of the third embodiment includes the nonlinear parameters (Bl(x), Kms(x)) for the speaker unit 50 and the nonlinear parameter (Rap2(Vp)) associated with the sound port 60. As in the first embodiment, the control apparatus 11 calculates the input voltage u* by the second processing S2 in which the target parameter (specifically, the volume velocity Vp) calculated by the first processing S1 is applied to the signal generating model G.

As described above, also in the third embodiment, the input voltage u* is determined by using the signal generating model G (nonlinear model M) that simulates a relationship in which the acoustic resistance Rap2(Vp) at the sound port 60 depends on the volume velocity Vp. Therefore, as in the first embodiment, it is possible to reduce the nonlinear distortion of the sound reproduced by the speaker apparatus 20.

In the target generating model F of the third embodiment, the nonlinear parameter (Rap2(Vp)) of the sound port 60 in the nonlinear model M is included. On the other hand, the nonlinear parameters (Bl(x), Kms(x)) of the nonlinear model M associated with the speaker unit 50 are linearized. Therefore, in the third embodiment, the nonlinear distortion attributable to the speaker unit 50 can be reduced from the reproduced sound of the speaker apparatus 20.

In a configuration (for example, the first embodiment) in which the nonlinear parameter (acoustic resistance Rap2(Vp)) of the sound port 60 is linearized in the target generating model F, there is a possibility that the displacement x* of the diaphragm 54 in the speaker unit 50 may be overestimated. In a case in which the displacement x* of the diaphragm 54 is overestimated, a resulting nonlinear distortion such as harmonic distortion in the reproduced sound may not be sufficiently reduced. In the third embodiment, since the target generating model F includes the nonlinear parameter of the sound port, the displacement x* of the diaphragm 54 is suppressed from being overestimated in the distortion reduction processing. Therefore, in the reproduced sound of the speaker apparatus 20, an advantage is obtained in that the nonlinear distortion attributable to the speaker unit 50 can be reduced with high accuracy.

### D: Fourth Embodiment

In the fourth embodiment, the signal generating model G (nonlinear model M) applied to the second processing S2 differs from that in the first embodiment. Specifically, the signal generating model G of the fourth embodiment is expressed by the following Equations (11c) to (13c).

$$\begin{matrix}[ SIGNAL GENERATING MODEL G ] & \\ {x}^{*} = \frac{{C}_{af} ( {x}^{*} )}{{S}_{D}} ( {R}_{ap}^{′} {V}_{p} + {R}_{ap 2} ( {V}_{p} ) {V}_{p} + {M}_{ap}^{′} \frac{{dV}_{p}}{dt} ) + \frac{{x}_{p}}{{S}_{D}} & ( 11 c )\end{matrix}$$

$$Bl ( {x}^{*} ) {i}^{*} = {M}_{ms} \frac{{dv}^{*}}{dt} + {R}_{ms} {v}^{*} + {K}_{ms} ( {x}^{*} ) {x}^{*} + \frac{{S}_{D}}{{C}_{af}} ( {x}^{*} {S}_{D} - {x}_{p} ) \qquad ( 12 c )$$

$${u}^{*} = {R}_{e} {i}^{*} + {L}_{e} \frac{{di}^{*}}{dt} + Bl ( {x}^{*} ) {v}^{*} \qquad ( 13 c )$$

Equation (12c) and Equation (13c) of the signal generating model G are similar to those of Equation (12a) and Equation (13a) in the first embodiment. In Equation (11c) of the signal generating model G in the third embodiment, the acoustic compliance Caf set to a constant in the first embodiment is changed to a nonlinear parameter (acoustic compliance Caf(x)) that changes nonlinearly in accordance with the displacement x of the diaphragm 54. The acoustic compliance Caf(x) is acoustic compliance in the internal space 42 of the housing 40. The acoustic compliance Caf(x) is an example of a “third nonlinear parameter.”

The control apparatus 11 calculates the input voltage u* using the second processing S2 in which the target parameter (volume velocity Vp) is applied to the signal generating model G described above. In the first processing S1, the target parameter (volume velocity Vp) is calculated using the same target generating model F as that in the third embodiment expressed by Equations (8b) to (10b). That is, the target generating model F of the fourth embodiment includes the nonlinear parameter (Rap2(Vp)) of the sound port 60, and the nonlinear parameters (Bl(x), Kms(x)) of the speaker unit 50 and the nonlinear parameter (Caf(x)) associated with the acoustic compliance in the internal space 42 are linearized.

As described above, also in the fourth embodiment, the input voltage u* is determined by using the signal generating model G (nonlinear model M) that simulates a relationship in which the acoustic resistance Rap2(Vp) at the sound port 60 depends on the volume velocity Vp. Therefore, as in the first embodiment, it is possible to reduce the nonlinear distortion of the sound reproduced by the speaker apparatus 20.

Further, in the fourth embodiment, the signal generating model G includes the acoustic compliance Caf(x), which is a nonlinear parameter associated with the internal space 42 of the housing 40, and the acoustic compliance Caf(x) is linearized in the target generating model F. Therefore, according to the fourth embodiment, as in the third embodiment, the nonlinear distortion attributable to the speaker unit 50 can be reduced, and the nonlinear distortion attributable to the acoustic compliance Caf(x) can also be reduced from the reproduced sound.

### E: Fifth Embodiment

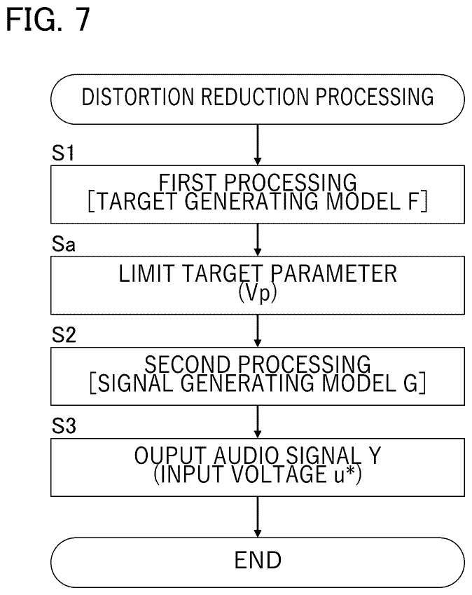

FIG. 7 is a flowchart of distortion reduction processing according to the fifth embodiment. When the idealized volume velocity Vp of the sound port 60 with respect to the audio signal X is calculated by the first processing S1, the control apparatus 11 limits the volume velocity Vp to a predetermined range (hereinafter, a “limited range”) (Sa). The limited range is a range from the minimum value Vmin to the maximum value Vmax. The minimum value Vmin and the maximum value Vmax are set experimentally or statistically such that noise components in a high-frequency range that cannot be reduced by the distortion reduction processing of the first embodiment are suppressed.

Specifically, the control apparatus 11 sets the volume velocity Vp to the minimum value Vmin in a case in which the volume velocity Vp calculated by the first processing S1 is lower than the minimum value Vmin. On the other hand, the control apparatus 11 sets the volume velocity Vp to be the maximum value Vmax in a case in which the volume velocity Vp exceeds the maximum value Vmax. The second processing S2, to which the volume velocity Vp after the limitation is applied, is the same as that in the above-described embodiments.

In the fifth embodiment, the same effects as those of the first embodiment are attainable. Further, in the fifth embodiment, since the volume velocity Vp applied to the nonlinear model M is set to a limited range, it is possible to suppress the energy of the nonlinear distortion that is difficult to sufficiently reduce in the nonlinear model M, in the reproduced sound of the speaker apparatus 20.

### F: Sixth Embodiment

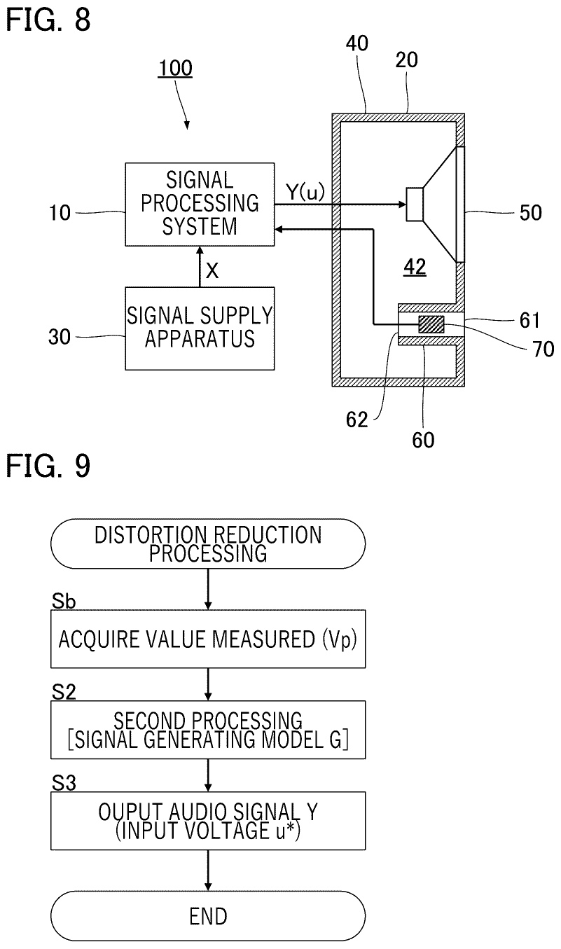

FIG. 8 is a schematic diagram of a speaker system 100 according to a sixth embodiment. As illustrated in FIG. 8, in the speaker system 100 of the sixth embodiment, a sensor 70 is added to the first embodiment.

The sensor 70 is a flow rate sensor that measures the volume velocity Vp inside the sound port 60. A flowmeter, such as an LDV (Laser Doppler Velocimeter) that optically detects air flow in the sound port 60, is used as the sensor 70.

FIG. 9 is a flowchart of distortion reduction processing according to the sixth embodiment. When the distortion reduction processing is started, the control apparatus 11 (signal processing unit) acquires a value measured by the sensor 70 (Sb). The control apparatus 11 determines the input voltage u* using the second processing S2 in which the measured value by the sensor 70 is applied as a volume velocity Vp of the nonlinear model M. Specifically, the nonlinear acoustic resistance Rap2(Vp) at the sound port 60 is set in accordance with the value measured by the sensor 70.

Steps S21 to S25 of the second processing S2 are the same as those of the first embodiment. Therefore, the same effects as those of the first embodiment can be realized in the sixth embodiment. In particular, in the sixth embodiment the volume velocity Vp detected by the sensor 70 in the sound port 60 is applied in the determination of the input voltage u*. That is, the actual sound wave behavior at the sound port 60 is taken into account in the determination of the input voltage u*. Therefore, the nonlinear distortion attributable to the sound port 60 can be reduced with high accuracy as compared with a configuration in which all numerical values used for determining the input voltage u* are determined by calculation.

### G: Modifications

Examples of modifications that can be made to the embodiments described above will now be described. Two or more aspects freely selected from the following examples may be combined in so far as they do not contradict each other.
(1) In the fifth embodiment, the nonlinear distortion is suppressed by setting the volume velocity Vp to a limited range, but a configuration and a process for suppressing the energy of the nonlinear distortion, which is difficult to sufficiently reduce using the nonlinear model M, are not limited to above examples. For example, nonlinear distortion may be reduced by performing signal processing on the audio signal X. Specifically, in the nonlinear model M, the control apparatus 11 performs signal processing on the audio signal X to suppress acoustic components in a high-frequency range, for which the nonlinear distortion is difficult to sufficiently reduce. The signal processing is, for example, equalization processing for adjusting the intensity of each band of the audio signal X. The control apparatus 11 determines the input voltage u by calculations Sa1-Sa5 of the nonlinear model M to which the audio signal X after the signal process is applied.
(2) In the sixth embodiment, the flowmeter for measuring the volume velocity is given as an example of the sensor 70, but the form of the sensor 70 is not limited to the above example. A pressure sensor (e.g., a MEMS sensor) that utilizes a sensing element such as a piezoelectric element or a capacitor may be used as the sensor 70 inside the sound port 60. The control apparatus 11 calculates the volume velocity Vp from the pressure measured by the sensor 70, and determines the input voltage u by a calculation to which the volume velocity Vp is applied.

In addition, in the sixth embodiment, the sensor 70 installed in the sound port 60 is given as an example, but a configuration in which the sensor 70 is installed in the sound port 60 is not essential. For example, the sensor 70 may be installed in the vicinity of the sound port 60. For example, a sensor 70 that collects radiated sound may be installed in the vicinity of the outer opening 61 of the sound port 60. An external microphone that detects ambient sound pressure, such as a dynamic microphone or a condenser microphone, is used as the sensor 70. The control apparatus 11 calculates a volume velocity Vp from the sound pressure detected by the sensor 70, and determines an input voltage u by an operation to which the volume velocity Vp is applied.

As will be understood from the above description, the sensor 70 is comprehensively represented as an element for detecting acoustic characteristics inside or in the vicinity of the sound port 60. The acoustic characteristics include volume velocity illustrated in the sixth embodiment, and pressure or sound pressure illustrated in the present modification.
(3) In each of the above-described embodiments, the speaker apparatus 20 includes a bass reflex port illustrated as the sound port 60. However, the type of the speaker apparatus 20 (enclosure type) is not limited to the above example.

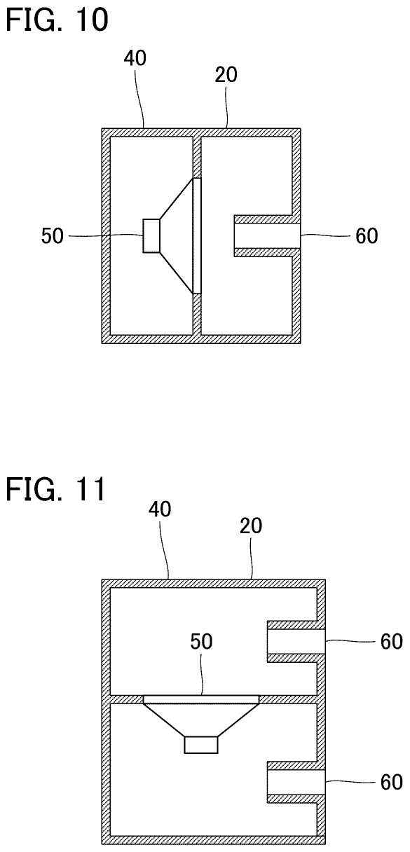

For example, as illustrated in FIG. 10, the above-described embodiments are similarly applied to the speaker apparatus 20, which is a Kelton-type, and in which sound radiated in front of the speaker unit 50 passes through the sound port 60. Further, as illustrated in FIG. 11, the above-described embodiments are similarly applied to a band-pass speaker apparatus 20 including a sound port 60 through which the sound radiated in front of the speaker unit 50 passes and the sound port 60 through which the sound radiated to the rear passes.

As will be understood from the above examples, the sound port 60 in the present disclosure is comprehensively represented as a port for sound radiation utilizing Helmholtz resonance of the sound radiated from the speaker unit 50, and it is not specified which direction of sound radiated from the speaker unit 50 passes through the port.
(4) In the sixth embodiment, the value measured by the sensor 70 is applied as the volume velocity Vp to the distortion reduction processing. However, the method of using the measurement value by the sensor 70 is not limited to the above example. For example, a form in which the relationship between the volume velocity Vp and the acoustic resistance Rap2(Vp) is identified in advance using the measured value by the sensor 70 is also envisaged.
(5) The method of determining the input voltage u using the nonlinear model M is not limited to the method illustrated in each of the above-described embodiments. A known technique can be freely employed for calculating the input voltage u using the nonlinear model M.
(6) In each of the above-described embodiments, the speaker system 100 in which the signal processing system 10 and the speaker apparatus 20 are separately configured is exemplified. However, the above-described embodiments are similarly applied to the speaker system 100 (active speaker) in which the signal processing system 10 is installed inside the housing 40. In addition, the speaker system 100 is realized as a stationary system, but can also be realized as a portable information apparatus, such as a smartphone, a tablet terminal, or a personal computer.
(7) As described above, the functions of the signal processing system 10 exemplified above are realized by cooperation of one or more processors constituting the control apparatus 11 and a program stored in the storage apparatus 12. The program according to this disclosure may be provided in a form stored in a computer-readable recording medium and installed in the computer. The recording medium is, for example, a non-transitory recording medium, and an optical recording medium (optical disk), such as a CD-ROM is one example, but any known type of recording medium, such as a semiconductor recording medium or a magnetic recording medium is also usable. A non-transitory recording medium includes any recording medium except for a transitory, propagating signal, and a volatile recording medium is not excluded. Further, in a configuration in which a distribution apparatus distributes the program via a communication network, the storage media that stores the program in the distribution apparatus corresponds to the non-transitory recording medium described above.
(8) The phrase “n” (n is a natural number) in the present application is used only as a formal and convenient label for distinguishing each element in the notation, and has no substantial meaning. Therefore, there is no room for restrictively interpreting the position, the order, or the like of each element on the basis of the notation “n.”

### H: Appendix

As examples, the following aspects are derivable from the embodiments above.

A speaker system according to an aspect (Aspect 1) of the present disclosure determines, by use of a nonlinear model, an input voltage based on a target parameter including a volume velocity at a sound port for sound radiation utilizing Helmholtz resonance, the nonlinear model simulating a relationship in which an acoustic resistance at the sound port depends on the volume velocity at the sound port; and supplies the input voltage to a speaker apparatus. In the above aspect, the input voltage to the speaker apparatus is determined by using a nonlinear model that simulates a relationship in which the acoustic resistance at the sound port depends on the volume velocity. Therefore, the nonlinear distortion of the sound reproduced by the speaker apparatus can be reduced.

In an example (Aspect 2) of Aspect 1, the nonlinear model includes a first nonlinear parameter representing a dependence of the acoustic resistance on the volume velocity, and the method further includes generating the target parameter by use of a target generating model in which the first nonlinear parameter of the nonlinear model is linearized. In the above aspect, the target parameter is generated using the target generating model in which the first nonlinear parameter is linearized, and the input voltage is determined from the target parameter. Therefore, it is possible to reduce the nonlinear distortion attributable to the sound port in the reproduced sound of the speaker apparatus.

The nonlinear model simulates a linear or nonlinear relationship in which the displacement, and additionally, velocity or acceleration, of the diaphragm in the speaker unit depends on a plurality of characteristics, such as electromagnetic force, mechanical resistance, or elastic force acting on each element of the speaker unit.

In an example (Aspect 3) of Aspect 2, the nonlinear model further includes a second nonlinear parameter associated with a speaker unit of the speaker apparatus, and the target generating model is a model in which the first nonlinear parameter and the second nonlinear parameter in the nonlinear model are linearized. In the above aspect, the target parameter is generated using the target generating model in which both the first nonlinear parameter and the second nonlinear parameter are linearized, and the input voltage is determined from the target parameter. Therefore, in addition to the nonlinear distortion attributable to the sound port, the nonlinear distortion attributable to the speaker unit can also be reduced.

In an example (Aspect 4) of Aspect 1, the nonlinear model includes a first nonlinear parameter representing a dependence of the acoustic resistance on the volume velocity, and a second nonlinear parameter associated with a speaker unit of the speaker apparatus, and the method further includes generating the target parameter by use of a target generating model that includes the first nonlinear parameter of the nonlinear model and the second nonlinear parameter is linearized. In the above aspect, the target parameter is generated by using the target generating model that includes the first nonlinear parameter and in which the second nonlinear parameter is linearized, and the input voltage is determined from the target parameter by using the nonlinear model. Therefore, the nonlinear distortion attributable to the speaker unit can be reduced in the reproduced sound of the speaker apparatus.

In an example (Aspect 5) of Aspect 1, the nonlinear model includes a first nonlinear parameter representing a dependence of the acoustic resistance on the volume velocity, a second nonlinear parameter associated with a speaker unit of the speaker apparatus, and a third nonlinear parameter associated with an acoustic compliance in the internal space of the speaker apparatus, and the method further includes generating the target parameter by use of a target generating model that includes the first nonlinear parameter of the nonlinear model and in which the second nonlinear parameter and the third nonlinear parameter are linearized. In the above aspect, the target parameter is generated by using the target generating model that includes the first nonlinear parameter and in which the second nonlinear parameter and the third nonlinear parameter are linearized, and the input voltage is determined from the target parameter by using the nonlinear model. Therefore, it is possible to reduce, in the reproduced sound of the speaker apparatus, the nonlinear distortion attributable to the speaker unit and the acoustic compliance in the reproduced sound of the speaker apparatus.

In an example (Aspect 6) of any of Aspects 1 to 5, the method further includes limiting the volume velocity to a predetermined range. According to the above aspect, by limiting the volume velocity applied to the nonlinear model to a predetermined range, it is possible to suppress the generation of noise attributable to the sound port, which is difficult to suppress in reproduced sound of the speaker apparatus even if the nonlinear model is used.

In an example (Aspect 7) of any of Aspects 1 to 6, the method further includes acquiring a detection result by a sensor that detects an acoustic characteristic inside or in the vicinity of the sound port, to determine the input voltage through an operation to which the detection result is applied. According to the above aspect, the result of the detection of the acoustic characteristic by the sensor inside or in the vicinity of the sound port is applied to the determination of the input voltage by the signal processing unit. That is, the actual sound wave behavior at the sound port is taken into account in the determination of the input voltage by the signal processor. Therefore, the nonlinear distortion can be reduced with high accuracy as compared with a form in which all numerical values used for determining the input voltage are determined by operations.

An “acoustic characteristic” is a variable applied to a nonlinear model. Specifically, characteristics such as flow velocity (volume flow rate) or pressure inside the sound port are detected by the sensor as acoustic characteristics.

The “in the vicinity of the sound port” is, for example, a space on the input side of the sound port (i.e., inside the housing of the speaker apparatus) or a space on the output side of the sound port (i.e., outside the housing of the speaker apparatus).

The “operation to which the detection result is applied” includes both
(1) a configuration in which a nonlinear function (for example, a relationship between a volume velocity and an acoustic resistance) in a nonlinear model is identified by using a detection result by a sensor; and
(2) a configuration in which the numerical value of a variable in the nonlinear model is controlled (for example, real-time feedback control) depending on the detection result by the sensor.

A signal processing system according to an aspect of the present disclosure includes: a signal processor configured to determine, by use of a nonlinear model, an input voltage based on a target parameter including a volume velocity at a sound port for sound radiation utilizing Helmholtz resonance, the nonlinear model simulating a relationship in which an acoustic resistance at the sound port depends on the volume velocity at the sound port; and a voltage supplier configured to supply the input voltage to a speaker apparatus. In the above aspect, the input voltage to the speaker apparatus is determined by using a nonlinear model that simulates a relationship in which the acoustic resistance at the sound port depends on the volume velocity. Therefore, it is possible to reduce the nonlinear distortion of the sound reproduced by the speaker apparatus. The above aspects (Aspects 2 to 6) of the signal processing method according to the present disclosure are similarly applied to the signal processing system according to the present disclosure.

A speaker system according to an aspect of the present disclosure includes a speaker unit; a sound port for sound radiation utilizing Helmholtz resonance of a sound radiated from the speaker unit; and a signal processing system. The signal processing system includes: a signal processor configured to determine, by use of a nonlinear model, an input voltage based on a target parameter including a volume velocity at the sound port, the nonlinear model simulating a relationship in which an acoustic resistance at the sound port depends on the volume velocity at the sound port; and a voltage supplier configured to supply the input voltage to a speaker apparatus. In the above aspect, the input voltage to the speaker apparatus is determined by using a nonlinear model that simulates a relationship in which the acoustic resistance at the sound port depends on the volume velocity. Therefore, it is possible to reduce the nonlinear distortion of the reproduced sound of the speaker apparatus.

### DESCRIPTION OF REFERENCE SIGNS

100 . . . speaker system, 10 . . . signal processing system, 11 . . . control apparatus, 12 . . . storage apparatus, 13 . . . input apparatus, 14 . . . output apparatus, 20 . . . speaker apparatus, 30 . . . signal supply apparatus, 40 . . . housing, 41 . . . plate member, 50 . . . speaker unit, 51 . . . frame, 52 . . . magnet, 53 . . . voice coil, 54 . . . diaphragm, 55 . . . edge, 56 . . . damper, 60 . . . sound port, 70 . . . sensor.

1. A signal processing method implemented by a computer system, the method comprising:
determining, by use of a nonlinear model, an input voltage based on a target parameter including a volume velocity at a sound port for sound radiation utilizing Helmholtz resonance, the nonlinear model simulating a relationship in which an acoustic resistance at the sound port depends on the volume velocity at the sound port; and
supplying the input voltage to a speaker apparatus.

2. The signal processing method according to claim 1,
wherein the nonlinear model includes a first nonlinear parameter representing a dependence of the acoustic resistance on the volume velocity,
the method further comprising:
generating the target parameter by use of a target generating model in which the first nonlinear parameter of the nonlinear model is linearized.

3. The signal processing method according to claim 2, wherein:
the nonlinear model further includes a second nonlinear parameter associated with a speaker unit of the speaker apparatus, and
the target generating model is a model in which the first nonlinear parameter and the second nonlinear parameter in the nonlinear model are linearized.

4. The signal processing method according to claim 1,
wherein the nonlinear model includes a first nonlinear parameter representing a dependence of the acoustic resistance on the volume velocity, and a second nonlinear parameter associated with a speaker unit of the speaker apparatus,
the method further comprising:
generating the target parameter by use of a target generating model that includes the first nonlinear parameter of the nonlinear model and in which the second nonlinear parameter is linearized.

5. The signal processing method of claim 1,
wherein the nonlinear model includes a first nonlinear parameter representing a dependence of the acoustic resistance on the volume velocity, a second nonlinear parameter associated with a speaker unit of the speaker apparatus, and a third nonlinear parameter associated with an acoustic compliance in an internal space of the speaker apparatus,
the method further comprising:
generating the target parameter by use of a target generating model that includes the first nonlinear parameter of the nonlinear model and in which the second nonlinear parameter and the third nonlinear parameter are linearized.

6. The signal processing method according to claim 1 further comprising:
limiting the volume velocity to a predetermined range.

7. The signal processing method according to claim 1 further comprising:
acquiring a detection result by a sensor that detects an acoustic characteristic inside or in a vicinity of the sound port, to determine the input voltage through an operation to which the detection result is applied.

8. A signal processing system comprising:
a signal processor configured to determine, by use of a nonlinear model, an input voltage based on a target parameter including a volume velocity at a sound port for sound radiation utilizing Helmholtz resonance, the nonlinear model simulating a relationship in which an acoustic resistance at the sound port depends on the volume velocity at the sound port; and
a voltage supplier configured to supply the input voltage to a speaker apparatus.

9. The signal processing system according to claim 8,
wherein the nonlinear model includes a first nonlinear parameter representing a dependence of the acoustic resistance on the volume velocity,
the system further comprising:
a target generator configured to generate the target parameter by use of a target generating model in which the first nonlinear parameter of the nonlinear model is linearized.

10. The signal processing system according to claim 9, wherein:
the nonlinear model further includes a second nonlinear parameter associated with a speaker unit of the speaker apparatus, and
the target generating model is a model in which the first nonlinear parameter and the second nonlinear parameter in the nonlinear model are linearized.

11. The signal processing system according to claim 8,
wherein the nonlinear model includes a first nonlinear parameter representing a dependence of the acoustic resistance on the volume velocity, and a second nonlinear parameter associated with a speaker unit of the speaker apparatus,
the system further comprising:
a target generator configured to generate the target parameter by use of a target generating model that includes the first nonlinear parameter of the nonlinear model and in which the second nonlinear parameter is linearized.

12. The signal processing system according to claim 8,
wherein the nonlinear model includes a first nonlinear parameter representing a dependence of the acoustic resistance on the volume velocity, a second nonlinear parameter associated with a speaker unit of the speaker apparatus, and a third nonlinear parameter associated with an acoustic compliance in an internal space of the speaker apparatus,
the system further comprising:
a target generator configured to generate the target parameter by use of a target generating model that includes the first nonlinear parameter of the nonlinear model and in which the second nonlinear parameter and the third nonlinear parameter are linearized.

13. A speaker system comprising:
a speaker unit;
a sound port for sound radiation utilizing Helmholtz resonance of a sound radiated from the speaker unit; and
a signal processing system,
wherein the signal processing system comprises:
a signal processor configured to determine, by use of a nonlinear model, an input voltage based on a target parameter including a volume velocity at the sound port, the nonlinear model simulating a relationship in which an acoustic resistance at the sound port depends on the volume velocity at the sound port; and
a voltage supplier configured to supply the input voltage to a speaker apparatus.

14. The speaker system according to claim 13,
wherein the nonlinear model includes a first nonlinear parameter representing a dependence of the acoustic resistance on the volume velocity,
the signal processing system further comprising:
a target generator configured to generate the target parameter by use of a target generating model in which the first nonlinear parameter of the nonlinear model is linearized.

15. The speaker system according to claim 14, wherein:
the nonlinear model further includes a second nonlinear parameter associated with the speaker unit of the speaker apparatus, and
the target generating model is a model in which the first nonlinear parameter and the second nonlinear parameter in the nonlinear model are linearized.

16. The speaker system according to claim 13,
wherein the nonlinear model includes a first nonlinear parameter representing a dependence of the acoustic resistance on the volume velocity, and a second nonlinear parameter associated with the speaker unit of the speaker apparatus,
the signal processing system further comprising:
a target generator configured to generate the target parameter by use of a target generating model that includes the first nonlinear parameter of the nonlinear model and in which the second nonlinear parameter is linearized.

17. The speaker system according to claim 13,
wherein the nonlinear model includes a first nonlinear parameter representing a dependence of the acoustic resistance on the volume velocity, a second nonlinear parameter associated with the speaker unit of the speaker apparatus, and a third nonlinear parameter associated with an acoustic compliance in an internal space of the speaker apparatus,
the signal processing system further comprising:
a target generator configured to generate the target parameter by use of a target generating model that includes the first nonlinear parameter of the nonlinear model and in which the second nonlinear parameter and the third nonlinear parameter are linearized.
